(19) United States
(12) Patent Application Publication
(10) Pub. No.: US 2018/0332258 A1
(43) Pub. Date: Nov. 15, 2018

(54) PHOSPHOR WHEEL

(71) Applicant: Panasonic Intellectual Property Management Co., Ltd., Osaka (JP)

(72) Inventors: SHINNOSUKE AKIYAMA, Osaka (JP); MASATO MORI, Hyogo (JP); KEI TOYOTA, Osaka (JP)

(21) Appl. No.: 15/956,420

(22) Filed: Apr. 18, 2018

(30) Foreign Application Priority Data
May 11, 2017 (JP) 2017-094970

(51) Int. Cl. H04N 9/31; G03B 21/20; G02B 26/00

(52) U.S. Cl. CPC H04N 9/3111; G02B 26/008; G03B 21/204

(57) ABSTRACT

A phosphor wheel capable of suppressing reduction in fluorescence output, which responds to irradiation of laser light with high output density. The phosphor wheel having a plate shape includes a substrate having light transmission properties and a phosphor layer stacked on the substrate and emitting fluorescence by irradiation of excitation light, in which the substrate and the phosphor layer are interlaced with each other at a contact portion between the substrate and the phosphor layer.

### TECHNICAL FIELD

The technical field mainly relates to a phosphor wheel, particularly to a phosphor wheel for obtaining fluorescence by excitation using laser light with high output density.

### BACKGROUND

In recent years, apparatuses that project videos toward a screen or a wall are widely used. One type of apparatus, a projector, controls light emitted from a light source by a spatial light modulator mounted on the projector to thereby convert the light into a video signal to be projected.

As the light source for the projector, a discharge light source such as an ultra-high pressure mercury lamp which obtains light emission by using arc discharge in mercury vapor has been commonly used in related art for projecting a large screen video. The light source has an advantage that continuous spectral light from an ultraviolet region to a visible region can be emitted. On the other hand, there are problems in that there is a delay in the light source emitting the light once it has been turned on and that there are limitations in increasing the luminance of the light source.

Under such circumstances, development of a projector including a light source in which laser light is combined with a phosphor is accelerating. Laser light can be momentarily turned on and can be condensed to a diffraction limit by condensing light using a lens as compared with the related-art light source, therefore, realizing further increase in luminance. A phosphor wheel in which a phosphor layer is formed on a circular substrate rotates inside the projector. When a phosphor layer portion is irradiated with laser light condensed by an optical member formed inside the projector, fluorescence is emitted, and projection of a video with high luminance is realized.

However, when the output density of laser light is increased, a heating value is increased as light energy is concentrated in a small area. Deterioration in the phosphor layer due to the increase of the heating value becomes a problem.

In order to solve the above problem, a phosphor wheel including a substrate that transmits light, a phosphor layer coated on the surface of the substrate and heat sinks adhered to at least one of an inner side as a rotation axis side of the phosphor layer and an outer side as the opposite side of the rotation axis of the phosphor layer so as to avoid a light path of light passing through the phosphor layer is disclosed in JP-A-2012-008177 (Patent Literature 1). As disclosed here, a mixed material including phosphor powder and a resin having light transmission properties, that is, a so-called resin binder material, is coated on the circular substrate, thereby forming the phosphor layer in a common phosphor wheel.

### SUMMARY

However, when laser light having a higher output density as compared with a current state is emitted for further increasing luminance of the projector, high heat is generated in the phosphor layer. The color of the resin having light transmission properties is changed due to the heat. A phenomenon in which the color of the resin finally changes into black occurs when the resin can no longer resist the heat. Accordingly, the laser light having high output density is absorbed by the resin and therefore, an amount of laser light that reaches the phosphor particles is reduced. Consequently, there arises a problem in that the amount of light emitted from the phosphor particles, namely, a fluorescence output is reduced, and it is difficult to project a video with high luminance.

In view of the above problems, as well as other concerns, a phosphor wheel capable of suppressing the reduction in fluorescence output, which responds to irradiation of laser light with high output density, is provided.

A phosphor wheel having a plate shape according to an embodiment includes a substrate having light transmission properties and a phosphor layer stacked on the substrate and emitting fluorescence by irradiation of excitation light, in which the substrate and the phosphor layer are interlaced with each other at a contact portion between the substrate and the phosphor layer.

In the phosphor wheel according to the embodiment, the phosphor layer is directly stacked on the substrate without using resin binder. Accordingly, when the phosphor wheel is irradiated with high output density laser light, absorption of laser light is suppressed as the resin binder layer does not exist. As an output of laser emitted to the phosphor layer is not reduced, reduction in fluorescent output can be suppressed.

### BRIEF DESCRIPTION OF THE DRAWINGS

FIG. 1 is a plan view of a phosphor wheel according to Embodiment 1 seen from above.

FIG. 2 is a cross-sectional view of the phosphor wheel according to Embodiment 1.

FIG. 3 is a cross-sectional view showing a contact portion between a phosphor layer and a substrate having light transmission properties according to Embodiment 1.

FIG. 4 is a chart showing fluorescence spectra obtained when Y₃Al₅O₁₂ activated by Ce or Lu₃Al₅O₁₂ activated by Ce according to the embodiment is selected as the phosphor layer and combined with the substrate 2 having light transmission properties and irradiated with blue light.

FIGS. 5A to 5C are schematic views showing fabrication processes of the phosphor wheel according to Embodiment 1.

FIG. 6 is a bottom view of a crucible used at the time of fabricating the phosphor wheel according to Embodiment 1.

FIG. 7 is a schematic view showing a configuration of a system used for evaluating whether the color is changed or not and for measuring a fluorescence output between the phosphor layer and the substrate having light transmission properties at the time of irradiation of high-output laser light in the phosphor wheel according to Embodiment 1.

FIG. 8 is a schematic view showing a configuration of a system used for measuring a light emitting spot diameter of the phosphor wheel according to Embodiment 1.

FIG. 9 is a plan view of a phosphor wheel described in Patent Literature 1 seen from above.

FIG. 10 is a cross-sectional view of the phosphor wheel described in Patent Literature 1.

FIG. 11 is a cross-sectional enlarged view showing a contact portion between a phosphor layer and a substrate having light transmission properties in the phosphor wheel described in Patent Literature 1.

### DESCRIPTION OF EMBODIMENTS

### Background

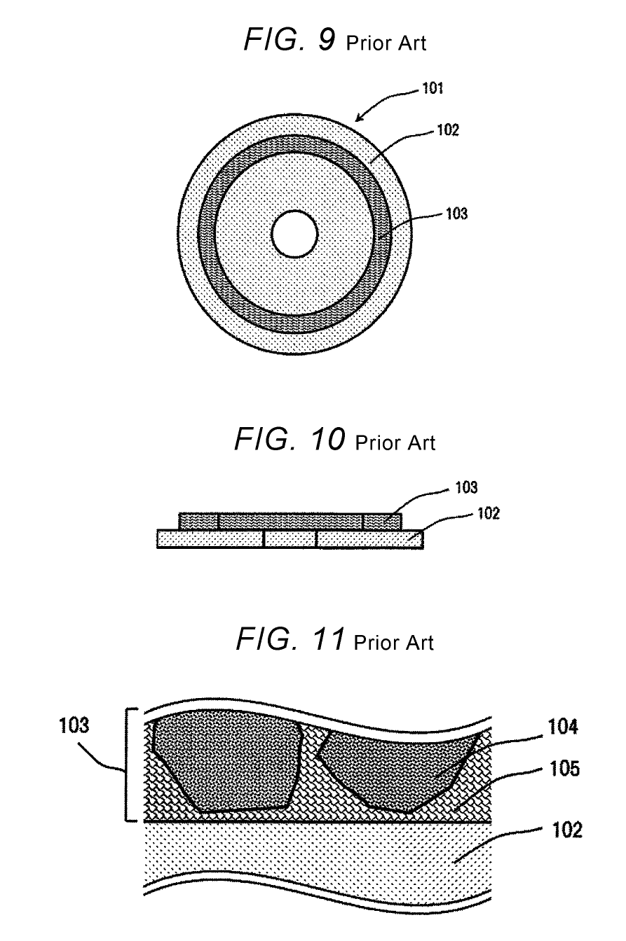

An embodiment will be explained with reference to the drawings as a reference example for showing validity. FIG. 9 is a plan view of a phosphor wheel 101 described in Patent Literature 1 seen from above. FIG. 10 is a cross-sectional view of the phosphor wheel 101 described in Patent Literature 1. The phosphor wheel 101 includes a substrate 102 having light transmission properties and an annular phosphor layer 103 provided on the substrate 102. FIG. 11 is a cross-sectional enlarged view showing a contact portion between the substrate 102 having light transmission properties and the phosphor layer 103 in the phosphor wheel 101 described in Patent Literature 1. In the contact portion between the substrate 102 and the phosphor layer 103, the substrate 102 and the phosphor layer 103 contact each other at an almost flat interface. The phosphor layer 103 includes phosphor particles 104 and a resin 105 having light transmission properties.

In the phosphor wheel 101 according to Patent Literature 1 shown in FIG. 11, the phosphor layer 103 is formed of the phosphor particles 104 and the resin 105 having light transmission properties. The phosphor layer 103 and the substrate 102 having light transmission properties are supported with each other by using the resin 105 having light transmission properties as a binder layer as shown in FIG. 11. When the phosphor layer 103 is irradiated with laser light from a direction of the substrate 102 having light transmission properties, the phosphor particles 104 inside the phosphor layer 103 absorb the laser light, and light emitted therefrom is used to thereby project a video on the screen.

Accordingly, the irradiated laser light passes through the substrate 102 having light transmission properties and the resin 105 having light transmission properties is irradiated with the laser light first. When the resin 105 having light transmission properties is irradiated with laser light with high output density, a phenomenon occurs in which the color of the resin 105 having light transmission properties is changed due to heat generation. Eventually, the resin 105 is burned and turns black. This is because the organic matter in the resin binder layer is decomposed by the heat. Accordingly, the laser light is absorbed by the black part before being emitted to the phosphor particles 104, and therefore, the amount of laser light reaching the phosphor particles 104 is reduced and a fluorescence output from the phosphor particles 104 is reduced.

Thus, the present inventors have found that absorption of laser light can be suppressed to thereby suppress reduction in fluorescence output by adopting a structure not including the resin 105 having light transmission properties as shown in FIG. 3 by using the structure of a phosphor wheel according to the present embodiment. That is, in the phosphor wheel according to the embodiment, the phosphor layer is stacked on the substrate without using resin.

Moreover, in the phosphor wheel according to the present embodiment, a contact portion between a phosphor layer 3 and a substrate 2 having light transmission properties has a structure in which the substrate 2 and the phosphor layer 3 are irregularly interlaced with each other. Here, the structure in which they are irregularly interlaced with each other is a structure shown in a cross-sectional enlarged view of the contact portion between the phosphor layer 3 and the substrate 2 having light transmission properties in the phosphor wheel according to Embodiment 1 in FIG. 3. The structure in which the substrate 2 and the phosphor layer 3 are irregularly interlaced with each other at the contact portion is formed, thereby increasing a contact area between the phosphor layer 3 and the substrate 2 having light transmission properties. Accordingly, heat generated in the phosphor layer 3 can be efficiently transmitted to the substrate 2 having light transmission properties.

The phosphor wheel having a plate shape according to a first aspect includes a substrate having light transmission properties and a phosphor layer stacked on the substrate and emitting fluorescence by irradiation of excitation light, in which the substrate and the phosphor layer are interlaced with each other at a contact portion between the substrate and the phosphor layer.

In the phosphor wheel according to a second aspect, the phosphor layer may be formed of an oxide material activated by Ce, and the substrate may be formed of Al₂O₃.

In the phosphor wheel according to a third aspect, the oxide material may include Y₃Al₅O₁₂ or Lu₃Al₅O₁₂.

In the phosphor wheel according to a fourth aspect, a thickness of the phosphor layer may be 50 μm or more and 350 μm or less.

Hereinafter, a phosphor wheel according to an embodiment will be explained with reference to the attached drawings.

### Embodiment 1

### <Phosphor Wheel>

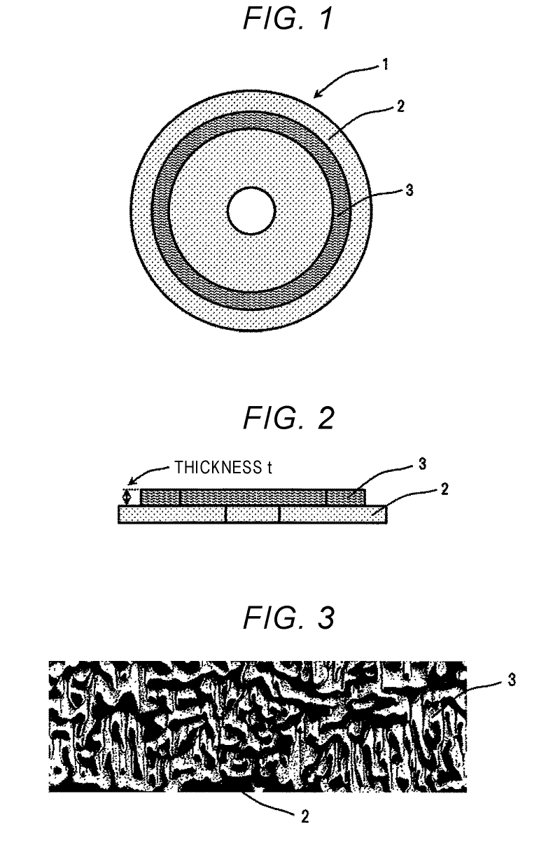

FIG. 1 is a plan view of a phosphor wheel 1 according to Embodiment 1 seen from above. FIG. 2 is a cross-sectional view of the phosphor wheel 1 according to Embodiment 1.

The phosphor wheel 1 according to Embodiment 1 is a plate-shaped phosphor wheel including a substrate 2 having light transmission properties and a phosphor layer 3 stacked on the substrate 2 and capable of emitting fluorescence by irradiation of excitation light. The phosphor wheel 1 has a structure in which the substrate 2 and the phosphor layer 3 are irregularly interlaced with each other at a contact portion between the substrate 2 and the phosphor layer 3.

In the phosphor wheel 1 according to Embodiment 1, the phosphor layer 3 is stacked on the substrate 2 without using a resin binder for dispersing a phosphor. Accordingly, when the phosphor wheel 1 is irradiated with laser light with high output density, absorption of the laser light is suppressed as the resin binder layer does not exist. Accordingly, as a laser output emitted to the phosphor layer is not reduced, it is possible to suppress reduction of the fluorescence output.

Furthermore, the contact portion between the phosphor layer 3 and the substrate 2 has a structure in which the substrate 2 and the phosphor layer 3 are irregularly interlaced with each other in the phosphor wheel 1. In the contact portion, a contact area between the phosphor layer 3 and the substrate 2 can be increased according to the above structure, and heat generated in the phosphor layer 3 can be efficiently transmitted to the substrate 2.

Hereinafter, components included in the phosphor wheel 1 will be explained.

### <Substrate>

The substrate 2 having light transmission properties has a plate shape, for example, a disc shape, having a circular opening in the center thereof. The substrate is not limited to the circular shape but maybe a polygonal shape. The opening is provided for installing a shaft of a motor necessary for rotating the phosphor wheel 1, and the substrate 2 having light transmission properties can be rotated around the shaft.

### <Phosphor Layer>

The phosphor layer 3 is an annular layer having the center that is substantially the same as the center of the substrate 2 having light transmission properties. The substrate 2 and the phosphor layer 3 are irregularly interlaced with each other at the contact portion between the substrate 2 having light transmission properties and the phosphor layer 3. FIG. 3 is a cross-sectional enlarged view of the contact portion between the phosphor layer 3 according to the embodiment and the substrate 2 having light transmission properties. In the contact portion, one of the phosphor layer 3 and the substrate 2 may be distributed in irregular shapes of islands in the other as a matrix. It is also preferable that both may be configured in a comb-teeth shape respectively.

When the phosphor layer 3 is irradiated with laser light from a direction of the substrate 2 having light transmission properties, namely, from a normal line direction of the substrate 2, light passing through the substrate 2 is absorbed by the phosphor layer 3 and fluorescence is emitted from the phosphor layer 3.

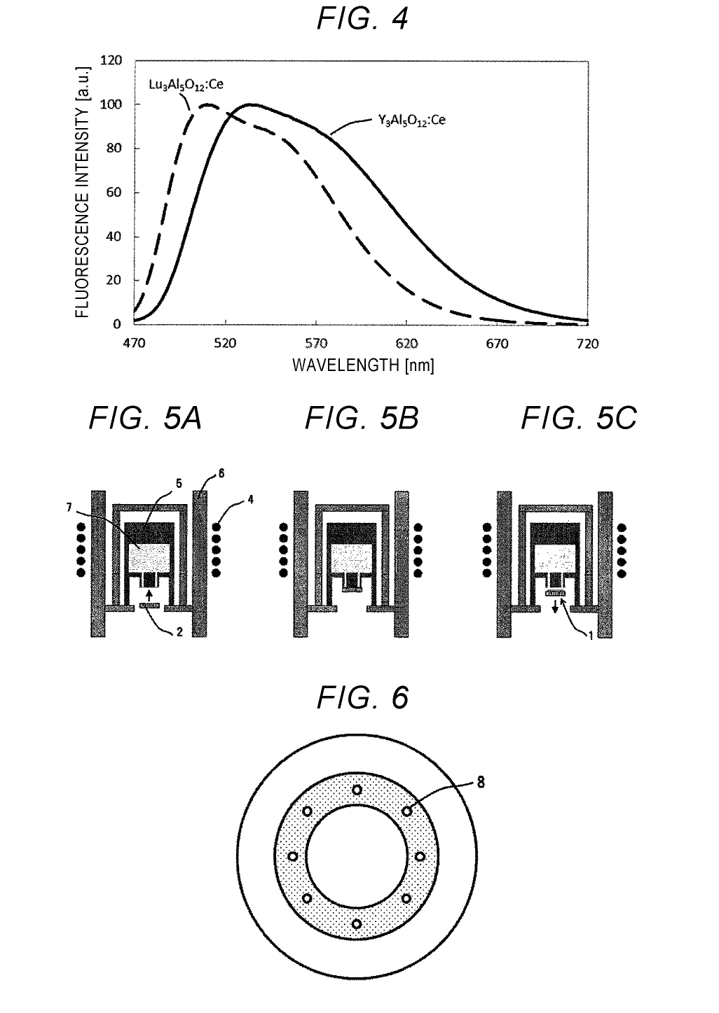

It is preferable that the phosphor layer 3 is formed of an oxide material activated by Ce and that the substrate 2 is formed of Al₂O₃. Among oxide materials, Y₃Al₅O₁₂ or Lu₃Al₅O₁₂ is preferably used. As Y₃Al₅O₁₂ and Lu₃Al₅O₁₂ has an eutectic composition with respect to Al₂O₃, the structure in which they are irregularly interfaced with each other can be obtained. When the phosphor is excited with blue light, the blue light is required to be converted into light in a visible region for outputting a video signal. FIG. 4 shows fluorescence spectra obtained when Y₃Al₅O₁₂ activated by Ce or Lu₃Al₅O₁₂ activated by Ce as the phosphor layer 3 according to the embodiment is combined with the substrate 2 having light transmission properties and irradiated with blue light. As the light in the visible region can be generated by blue-light excitation as shown in FIG. 4, light components necessary for outputting the video signal can be obtained. Accordingly, Y₃Al₅O₁₂ and Lu₃Al₅O₁₂ are preferable among the oxide materials activated by Ce.

A thickness of the phosphor layer 3 is preferably 50 μm or more and 350 μm or less. In a case where the thickness of the phosphor layer 3 is smaller than 50 μm, blue light is not sufficiently converted into fluorescence in the phosphor layer 3, therefore, the fluorescence output is reduced. In a case where the thickness of the phosphor layer 3 is larger than 350 μm, blue light is sufficiently converted in the phosphor layer 3 but a scattering effect inside the phosphor layer 3 is increased as the thickness of the phosphor layer 3 is increased, which widens the fluorescence. When the obtained fluorescence is widened, it is necessary to condense light by a large optical lens, which is not suitable to be applied to products. Accordingly, the thickness of the phosphor layer 3 is preferably 50 μm or more and 350 μm or less.

### (Manufacturing Method of Phosphor Wheel)

Hereinafter, a manufacturing method of the phosphor wheel will be explained in more detail.

A crystal pulling-down apparatus can be used for fabricating the phosphor wheel 1 according to Embodiment 1. FIGS. 5A to 5C are schematic views showing fabrication processes of the phosphor wheel according to Embodiment 1. FIG. 5A is a schematic view showing a state in which base powder is made to be a melt 7. FIG. 5B is a schematic view showing a state in which the substrate 2 having light transmission properties is allowed to contact a bottom surface of a crucible 5. FIG. 5C is a schematic view showing a state in which the substrate 2 having light transmission properties is pulled down to fabricate the phosphor wheel 1. The crystal pulling-down apparatus includes a high-frequency coil 4 as a heating source, and the crucible 5 installed in the apparatus is heated due to principles of high-frequency induction heating. As it is difficult to make the temperature inside the crucible 5 uniform only by the crucible 5, a periphery of the crucible 5 is covered with a refractory material 6 for keeping the temperature uniform.

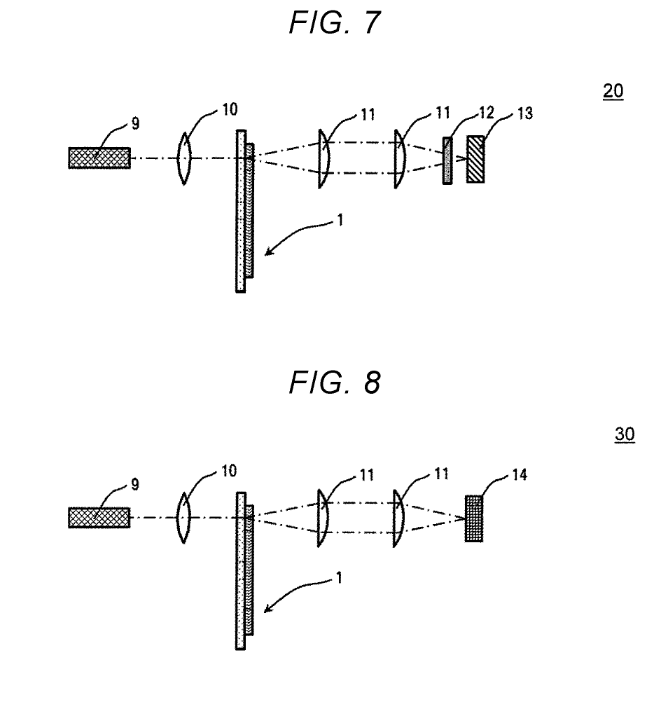

FIG. 6 is a bottom view of the crucible 5 used at the time of fabricating the phosphor wheel according to the embodiment. On a bottom surface of the crucible 5, holes 8 are located from which the melt flows out. That is, the bottom surface of the crucible 5 has a hollow circular shape corresponding to the shape of the phosphor layer 3 of the phosphor wheel 1, and plural holes 8 open on the hollow circular portion.
(a) First, when powder to be a raw material of the phosphor layer 3 is put into the crucible 5 and heated up to be a melting point of the raw material, the melt 7 of base powder is generated as shown in FIG. 5A.
(b) Next, as shown in FIG. 5B, the substrate 2 having light transmission properties is allowed to contact the bottom surface of the crucible 5. When the substrate 2 having light transmission properties is allowed to contact the bottom surface of the crucible 5, the melt 7 leaks out and is spread on the substrate 2 having light transmission properties through the holes 8 on the bottom surface portion of the crucible 5. When the melt 7 leaks out and is spread until the melt 7 becomes the same shape as the bottom surface portion of the crucible 5 above the substrate 2 having light transmission properties, the melt 7 is maintained by a surface tension of the melt itself.
(c) The substrate 2 having light transmission properties is pulled down and is naturally cooled in the above state as shown in FIG. 5C. The melt 7 above the substrate 2 having light transmission properties is coagulated to be the phosphor layer 3. In a portion where the substrate 2 having light transmission properties contacts the melt 7, respective components of the substrate 2 and the melt 7 are melted on a surface portion of the substrate 2 having light transmission properties and coagulated in a state where respective components are stable (eutectic composition in the case where they have an eutectic point) at the time of cooling.

According to the above processes, it is possible to fabricate the phosphor wheel 1 having the structure in which the phosphor layer 3 and the substrate 2 having light transmission properties are irregularly interlaced with each other at the contact portion thereof.

### EXAMPLES 1 TO 5

In Examples 1 to 5, aluminum oxide (Al₂O₃) powder having a purity of 99.9%, yttrium oxide (Y₂O₃) powder and cerium oxide (CeO₂) were mixed at a given ratio for fabricating Y₃Al₅O₁₂ activated by Ce, which was heated under a nitrogen atmosphere at 1200° C. for two hours to obtain a sintered body of Y₃Al₅O₂₂ activated by Ce.

The sintered body was put into the crucible 5 and the output of the high-frequency coil 4 is increased to thereby make the sintered body be the melt 7 under a nitrogen atmosphere. The heating temperature at this time is controlled at 50° C. or more to 100° C. or less with respect to a melting point to the sintered body so that the sintered body is completely melted and does not flow out from the holes 8 of the crucible 5 by its own weight.

After that, the substrate 2 having light transmission properties was allowed to contact the bottom portion of the crucible 5 to allow the melt 7 to leak out and be spread. Then, the substrate 2 having light transmission properties was gradually pulled down to coagulate the melt 7, thereby fabricating the phosphor layer 3. After checking that the phosphor layer 3 had a desired thickness, the heating of the crucible 5 was stopped, thereby stopping the flow of the melt 7 and taking out the phosphor wheel 1.

The resulting phosphor layer 3 of the fabricated phosphor wheel 1 had an uneven surface. Accordingly, the thickness of the phosphor layer 3 was made uniform by using a device such as a surface planer capable of performing planarization of a workpiece with high accuracy. The thickness in this case means a distance from the surface of the substrate 2 having light transmission properties to the surface of the phosphor layer 3 as shown in FIG. 2. Phosphor wheels 1 having phosphor layers 3 with thicknesses of 50 μm, 100 μm, 200 μm, 300 μm, and 350 μm were fabricated.

### Examples 6 to 8

In Examples 6 to 8, aluminum oxide (Al₂O₃) powder having a purity of 99.9%, lutetium oxide (Lu₂O₃) powder and cerium oxide (CeO₂) were mixed at a given ratio for fabricating Lu₃Al₅O₁₂ activated by Ce, which was heated under a nitrogen atmosphere at 1200° C. for two hours to obtain a sintered body of Lu₃Al₅O₁₂ activated by Ce. The fabrication processes were the same as those of Examples 1 to 5, and phosphor wheels 1 having phosphor layers 3 with thicknesses of 50 μm, 200 μm, and 350 μm were fabricated.

### Comparative Example 1 and Comparative Example 2

In Comparative Example 1 and Comparative Example 2, raw materials and fabrication processes which are the same as those of Examples 1 to 5 were used, and phosphor wheels 1 having phosphor layers 3 with thicknesses of 40 μm, and 400 μm were fabricated.

### Comparative Example 3 and Comparative Example 4

In Comparative Example 3 and Comparative Example 4, sintered bodies of Y₃Al₅O₁₂ and Lu₃Al₅O₁₂ activated by Ce were fabricated in the same manner as Examples 1 to 5 and Examples 6 to 8. After that, obtained fluorescent substances were mixed with a binder (resin material) and applied, thereby fabricating phosphor wheels 101.

### (Evaluation and Measurement of Phosphor Wheels)

Concerning the fabricated phosphor wheels, whether the color was changed or not was evaluated and, fluorescence outputs and light-emitting spot diameters were measured at the time of irradiation of high-output laser light.

FIG. 7 is a schematic view showing a configuration of a system 20 used for evaluating whether the color was changed or not and for measuring fluorescence outputs at the time of irradiation of high-output laser light in the fabricated phosphor wheels. The system 20 includes a blue laser 9, a convex lens (f200) 10, a flat convex lens (f75) 11, a blue light cut filter 12 and a light output detector 13. FIG. 8 is a schematic view showing a configuration of a system 30 used for measuring light emitting spot diameters of the fabricated phosphor wheels. The system 30 for measuring light emitting spot diameters of the phosphor wheels includes the light laser 9, the convex lens (f200) 10, the flat convex lens (f75) 11 and a beam profiler 14.

Table 1 shows results obtained by evaluation on whether the color was changed or not and measurement of fluorescence outputs and light emitting spot diameters at the time of irradiating high-output laser light when the composition of the phosphor layers 3 and the substrates 2 having light transmission properties and the thickness of the phosphor layers 3 were respectively changed in the phosphor wheels according to Examples and Comparative Examples.

In order to evaluate whether the color was changed or not at the time of irradiating high-output laser light in the fabricated phosphor wheels, rotating phosphor wheels were irradiated with laser light so that an output density was 50 W/mm2, and whether the color was changed or not was checked.

In the column, whether color is changed or not in Table 1, determination was made as “changed” when color change was visually checked, and determination was made as “not changed” when color change was not visually checked.

Moreover, the phosphor layers 3 were irradiated with laser light for measuring fluorescence outputs of the fabricated phosphor wheels and light outputs of a generated fluorescent component were measured. An upper limit of detection values in the adopted light output detector 13 is 50 mV. Accordingly, when irradiation is performed so that the output density of the laser light is 50 W/mm², it is difficult to accurately detect light as the light output of the fluorescent component exceeds 50 mW. Accordingly, the output density of laser light to be emitted was reduced to 1.5 W/mm², and light outputs of the fluorescent component were measured within a range not exceeding the detection upper limit of the light output detector 13. Light from the phosphor wheel contains not only light of the fluorescent component but also light of a blue component from the blue laser 9 which passes through the phosphor wheel. Accordingly, the blue light cut filter 12 is installed in front of the light output detector 13 so as to measure only the light of the fluorescent component.

In the column, fluorescence output in Table 1, determination was made as “good” when the output is 30.00 mW is more, which is necessary for application to optical products and determination was made as “failure” when the output is lower than 30.00 mW.

Furthermore, light emitting spot diameters of the fabricated phosphor wheels were measured. When light from the phosphor wheel is detected by the beam profiler, a Gaussian curve can be obtained. Accordingly, the light emitting spot diameter was measured as a width in an intensity obtained when a value is dropped from a peak intensity value to 1/e² (13.5%) on the Gaussian curve.

In the column, light emitting spot diameter in Table 1, determination was made as “good” when the diameter was 0.5mm or more and 1.5mm or less which can obtain extraction efficiency, which is necessary for application to optical products, and determination was made as “failure” in other cases.

Lastly, in the comprehensive evaluation column, a determination was made as “good” when there were two “good”s in respective items of the fluorescence output and the light emitting spot diameter. In a case where at least one “failure” exists, a determination was made as “failure” (F) in the comprehensive evaluation regardless of results of other items. In a case where measurement was not possible, “Not available (N/A)” is written.

TABLE 1

| | | Substrate with | Thickness of | Whether color | | | Light | | |
|---|---|---|---|---|---|---|---|---|---|
| | | light transmission | phosphor layer | was changed | Fluorescence | | emitting spot | | Comprehensive |
| | Phosphor layer | properties | [μm] | or not | output | | diameter | | evaluation |
| Example 1 | Y₃Al₅O₁₂:Ce | Al₂O₃ | 50 | Not changed | 30.2 | Good | 0.62 | Good | Good |
| Example 2 | Y₃Al₅O₁₂:Ce | Al₂O₃ | 100 | Not changed | 32.6 | Good | 0.72 | Good | Good |
| Example 3 | Y₃Al₅O₁₂:Ce | Al₂O₃ | 200 | Not changed | 36.3 | Good | 1.05 | Good | Good |
| Example 4 | Y₃Al₅O₁₂:Ce | Al₂O₃ | 300 | Not changed | 40.0 | Good | 1.34 | Good | Good |
| Example 5 | Y₃Al₅O₁₂:Ce | Al₂O₃ | 350 | Not changed | 41.8 | Good | 1.50 | Good | Good |
| Example 6 | Lu₃Al₅O₁₂:Ce | Al₂O₃ | 50 | Not changed | 30.4 | Good | 0.61 | Good | Good |
| Example 7 | Lu₃Al₅O₁₂:Ce | Al₂O₃ | 200 | Not changed | 36.6 | Good | 1.03 | Good | Good |
| Example 8 | Lu₃Al₅O₁₂:Ce | Al₂O₃ | 350 | Not changed | 41.2 | Good | 1.48 | Good | Good |
| Comparative | Y₃Al₂O₁₂:Ce | Al₂O₃ | 40 | Not changed | 29.8 | F | 0.59 | Good | F |
| Example 1 | | | | | | | | | |
| Comparative | Y₃Al₅O₁₂:Ce | Al₂O₃ | 400 | Not changed | 41.5 | Good | 1.70 | F | F |
| Example 2 | | | | | | | | | |
| Comparative | Y₃Al₅O₁₂:Ce + | Al₂O₃ | 100 | Changed | N/A | F | N/A | F | F |
| Example 3 | resin binder | | | | | | | | |
| Comparative | Lu₃Al₅O₁₂:Ce + | Al₂O₃ | 100 | Changed | N/A | F | N/A | F | F |
| Example 4 | resin binder | | | | | | | | |

(Whether Color of Phosphor Wheel was Changed or not)

The substrate 2 having light transmission properties and the phosphor layer 3 are formed of inorganic oxides in Example 1 to Example 8 and Comparative Example 1 and Comparative Example 2. On the other hand, the phosphor layer 103 is formed of the phosphor particles 104 and the resin 105 having light transmission properties in Comparative Example 3 and Comparative Example 4. When the laser light with high output density was emitted, the color of the resin 105 having light transmission properties was changed and turned black immediately in Comparative Example 3 and Comparative Example 4. However, color change was not observed in Example 1 to Example 8 and Comparative Example 1 and Comparative Example 2. This is because an organic component contained in the resin having light transmission properties used in Comparative Example 3 and Comparative Example 4 causes a decomposition reaction due to the irradiation of high-output laser light. On the other hand, it can be considered that the color was not changed in Example 1 to Example 8 and Comparative Example 1 and Comparative Example 2 as the substrate 2 having light transmission properties and the phosphor layer 3 are formed of inorganic oxides.

### (Fluorescence Output and Light Emitting Spot Diameter)

As the resin having light transmission properties was turned black in Comparative Example 3 and Comparative Example 4 as described above, emitted laser light was absorbed, and fluorescence outputs were not detected. Therefore, “failures” are marked as the comprehensive evaluation.

Example 1 to Example 5 will be compared with Comparative Example 1 and Comparative Example 2.

In Example 1 to Example 5 in which the thickness of the phosphor layer 3 is 50 μm or more and 350 μm or less, the fluorescence outputs and the light emitting spot diameters are good. Therefore, the comprehensive evaluations are “good”. However, in Comparative Example 1 in which the thickness of the phosphor layer 3 is 40 μm, the light emitting spot diameter is reduced as the thickness is small. However, the fluorescence output is reduced as the possibility in which excitation light is converted in the phosphor layer 3 is reduced. On the other hand, in Comparative Example 2 in which the thickness of the phosphor layer 3 is 400 μm, the possibility in which excitation light is converted in the phosphor layer 3 is increased and the fluorescence output is increased, however, the light emitting spot diameter is increased as the thickness is large. Accordingly, the comprehensive evaluations of Comparative Example 1 and Comparative Example 2 are determined as “failure”.

As shown in the above Examples, even when the phosphor wheel is irradiated with laser light with high output density, absorption of the laser light is suppressed and reduction in fluorescence output can be suppressed as the resin binder layer the color of which is changed by heat does not exist in the phosphor wheel according to the embodiment.

Furthermore, in the phosphor wheel according to the embodiment, the contact area between the phosphor layer 3 and the substrate 2 having light transmission properties can be increased by adopting the structure in which the substrate 2 and the phosphor layer 3 are irregularly interlaced at the contact portion. Accordingly, heat generated in the phosphor layer 3 can be efficiently transmitted to the substrate 2 having light transmission properties.

The present disclosure includes suitable combinations of arbitrary embodiments and/or examples in the above various embodiments and/or examples, and advantages possessed by respective embodiments and/or examples can be obtained.

As described above, the phosphor wheel according to the present embodiment can suppress reduction in fluorescence output due to the color change of resin as the phosphor layer is stacked on the substrate without using resin. Accordingly, the phosphor wheel is suitable to be applied to a projector provided with a laser light source with high output density.

What is claimed is:

1. A phosphor wheel having a plate shape comprising:
a substrate having light transmission properties; and
a phosphor layer stacked on the substrate and emitting fluorescence by irradiation of excitation light,
wherein the substrate and the phosphor layer are interlaced with each other at a contact portion between the substrate and the phosphor layer.

2. The phosphor wheel according to claim 1,
wherein the phosphor layer is formed of an oxide material activated by Ce, and
the substrate is formed of Al₂O₃.

3. The phosphor wheel according to claim 2,
wherein the oxide material includes Y₃Al₅O₁₂ or Lu₃Al₅O₁₂.

4. The phosphor wheel according to claim 1,
wherein a thickness of the phosphor layer is 50 μm or more and 350 μm or less.

5. The phosphor wheel according to claim 1,
wherein the phosphor wheel has a polygonal shape.

6. The phosphor wheel according to claim 1,
wherein the phosphor wheel has a circular opening in a center of the phosphor wheel.

7. The phosphor wheel according to claim 1,
wherein the substrate and the phosphor layer have a comb-teeth shape at the contact portion between the substrate and the phosphor layer.
